(19) United States
(12) Patent Application Publication
(10) Pub. No.: US 2010/0045668 A1
(43) Pub. Date: Feb. 25, 2010

(54) Apparatus and Method for 3D Packet Scale Down with Proxy Server in Mobile Environment

(75) Inventors: Jee-Hang Lee, Yongin-si (KR); Dong-Jun Kum, Yongin-si (KR); Soon-Hwan Kwon, Seongnam-si (KR); Seung-Jae Han, Hwaseong-si (KR); Dong-Jin Sohn, Seongnam-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/583,303

(22) Filed: Aug. 18, 2009

(30) Foreign Application Priority Data
Aug. 21, 2008 (KR) 10-2008-0082101

(51) Int. Cl. G06T 15/00; G06F 15/16

(52) U.S. Cl. 345/419; 709/246

(57) ABSTRACT

A mobile network capable of 3-Dimensional (3D) packet scale down includes a server, mobile station and proxy server. The proxy server includes an apparatus and method for 3-Dimensional (3D) packet scale down. The method includes receiving a 3D packet from a main server, generating a set of unit figures constituting a 3D image using a parameter of the received 3D packet, and increasing a size of a partial unit figure in the generated set of the unit figures, and generating a set of the same size as the generated set of the unit figures, by figures of less number than the generated set of the unit figures.

### CROSS-REFERENCE TO RELATED APPLICATION(S) AND CLAIM OF PRIORITY

The present application claims priority under 35 U.S.C. § 119(a) to a Korean Patent Application filed in the Korean Intellectual Property Office on “Aug. 21, 2008” and assigned Serial No. “10-2008-0082101”, the contents of which are herein incorporated by reference.

### TECHNICAL FIELD OF THE INVENTION

The present invention relates to an apparatus and method for scaling down a 3-Dimensional (3D) packet using a proxy server in a mobile environment. More particularly, the present invention relates to an apparatus and method for effectively servicing, by a Mobile Station (MS), a 3D graphic using a proxy server in a limited bandwidth, small memory environment, and low processor clock such as a mobile environment.

### BACKGROUND OF THE INVENTION

As a computing power of a Personal Computer (PC) becomes enormous and a network bandwidth increases day by day, an application or service using a 3-Dimensional (3D) technology also is rapidly increasing. From a stand-alone application on a PC to an on-line game using a network, the limit of its application is being expanded day by day. Accordingly, many researches are being made to realize the maximum performance and the best quality.

Particularly, with the rapid development of a wireless network environment, a 3D service in a mobile equipment attracts attention, and is now developed in many parts. However, 3D applications actually serviced in a mobile environment fail to satisfy users' eye levels because of a computing environment limited compared to a PC environment.

Thus, there is a need for a scheme for improving the performance and quality of a 3D graphic service in a mobile environment.

### SUMMARY OF THE INVENTION

To address the above-discussed deficiencies of the prior art, it is a primary aspect of the present invention to substantially solve at least the above problems and/or disadvantages and to provide at least the advantages below. Accordingly, one aspect of the present invention is to provide an apparatus and method for scaling down a 3-Dimensional (3D) packet using a proxy server in a mobile environment.

Another aspect of the present invention is to provide an apparatus and method for effectively servicing, by a Mobile Station (MS), a 3D graphic using a proxy server in a limited bandwidth, small memory environment, and low processor clock such as a mobile environment.

A further aspect of the present invention is to provide an apparatus and method for, by a proxy server, scaling down a 3D packet received from a main server and transmitting the scaled-down 3D packet of the same format to an MS and, by the MS, rendering the scaled-down 3D packet and providing a 3D graphic service to a user in a mobile environment.

The above aspects are achieved by providing an apparatus and method for 3D packet scale down with a proxy server in a mobile environment.

According to one aspect of the present invention, a method for processing a 3-Dimensional (3D) packet in a proxy server is provided. The method includes receiving a 3D packet from a main server, generating a set of unit figures constituting a 3D image using a parameter of the received 3D packet, and increasing a size of a partial unit figure in the generated set of the unit figures, and generating a set of the same size as the generated set of the unit figures, by figures of less number than the generated set of the unit figures.

According to another aspect of the present invention, an apparatus for processing a 3D packet in a proxy server is provided. The apparatus includes a packet receiver and a scale-down unit. The packet receiver receives a 3D packet from a main server. The scale-down unit generates a set of unit figures constituting a 3D image using a parameter of the received 3D packet, increases a size of a partial unit figure in the generated set of the unit figures, and generates a set of the same size as the generated set of the unit figures, by figures of less number than the generated set of the unit figures.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a diagram of a construction of a system of a mobile environment according to an exemplary embodiment of the present invention;

FIG. 2 illustrates a block diagram of a construction of an apparatus for scaling down and transmitting, by a proxy server, a 3-Dimensional (3D) packet to a Mobile Station (MS) in a mobile environment according to an exemplary embodiment of the present invention;

FIG. 3 illustrates a flow diagram for a procedure of a method for scaling down and transmitting, by a proxy server, a 3D packet to an MS in a mobile environment according to an exemplary embodiment of the present invention;

FIG. 4 illustrates a flow diagram for a procedure of a method for scaling down and transmitting, by a proxy server, a primitive packet to an MS in a mobile environment according to an exemplary embodiment of the present invention;

FIG. 5 illustrates a flow diagram for a procedure of a method for scaling down and transmitting, by a proxy server, a mesh packet to an MS in a mobile environment according to an exemplary embodiment of the present invention;

FIG. 6 illustrates a flow diagram for a procedure of a method for scaling down and transmitting, by a proxy server, a texture packet to an MS in a mobile environment according to an exemplary embodiment of the present invention;

FIG. 7 illustrates a diagram for an example of a method for scaling down, by a proxy server, a primitive packet in a mobile environment according to an exemplary embodiment of the present invention; and

FIG. 8 illustrates a diagram for an example of a method for scaling down, by a proxy server, a mesh packet in a mobile environment according to an exemplary embodiment of the present invention.

### DETAILED DESCRIPTION OF THE INVENTION

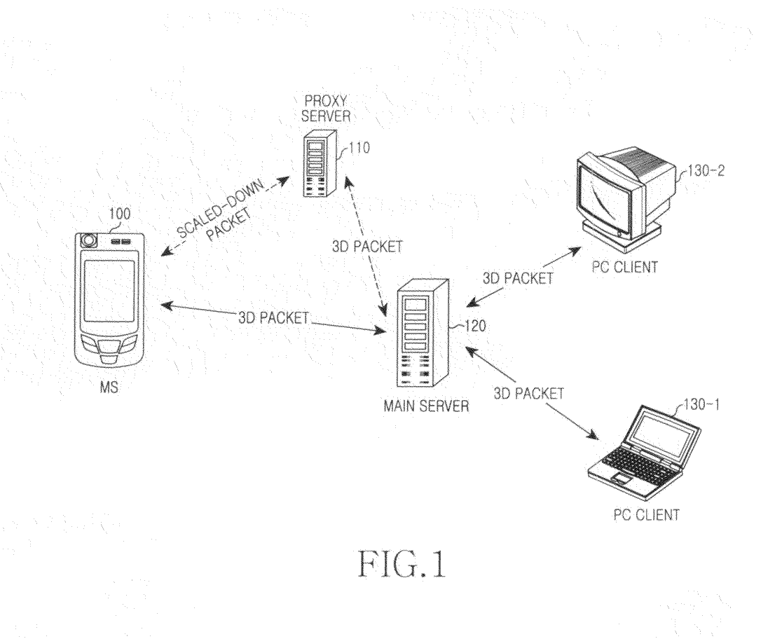

FIGS. 1 through 8, discussed below, and the various embodiments used to describe the principles of the present disclosure in this patent document are by way of illustration only and should not be construed in any way to limit the scope of the disclosure.

A scheme for scaling down a 3D packet using a proxy server in a mobile environment according to the present invention is described below.

As a 3D packet necessary for constituting one picture, there are a primitive packet, a mesh packet, and a texture packet. By receiving all the packets and rendering the received 3D packets, a MS can provide a 3D graphic service to a user.

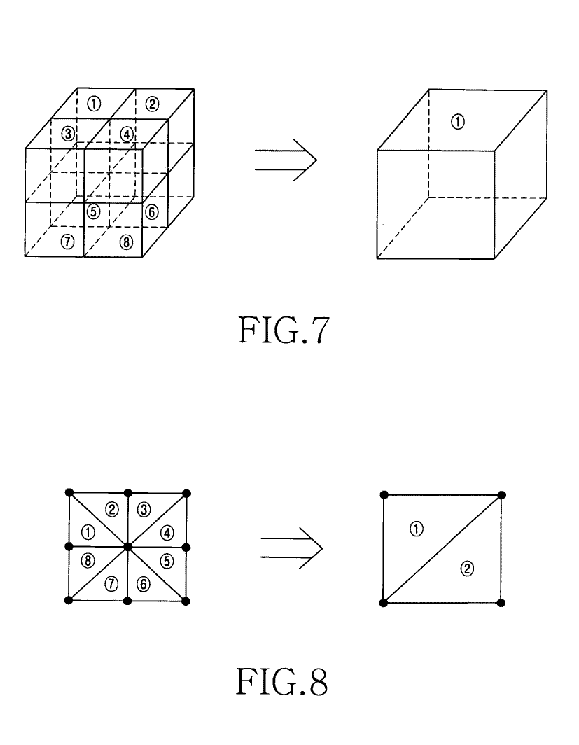

As illustrated in FIG. 7, a primitive is comprised of a set of unit space figures. The primitive is generated using a primitive parameter within a primitive packet. As illustrated in FIG. 8, a mesh is comprised of a set of points, and this is expressed by a set of unit plane figures (particularly, triangles that are 3D minimum constituent units). The mesh is generated using a mesh parameter within a mesh packet. Accordingly, the more points constituting the mesh are numerous, that is, the more the mesh becomes dense, the more a resolution of a picture gets high and simultaneously, even a size of a mesh packet increases as well. A texture packet includes a texture image to be given to the unit space figure.

FIG. 1 illustrates a diagram of a construction of a system of a mobile environment according to an exemplary embodiment of the present invention.

As illustrated in FIG. 1, the system includes a MS 100, a proxy server 110, a main server 120, and PC clients 130-1 and 130-2.

Referring to FIG. 1, the MS 100 includes a smart 3D render enabling high performance and high quality output therein. By rendering a scaled-down 3D packet received from the proxy server 110 using the internal render, the MS 100 provides a 3D graphic service quick with no delay and of good quality to a user. If the proxy server 110 does not exist, the MS 100 can directly access the main server 120 and, by rendering a 3D packet received from the main server 120 using the internal render, can provide a 3D graphic service to the user. The render reflects a special rendering technology necessary for a mobile 3D environment as well as visibility culling and accordingly, can improve performance and quality even in a limited computing environment.

The proxy server 110 is positioned between the main server 120 and the MS 100. The proxy server 110 scales down a 3D packet received from the main server 120, and transmits the scaled-down 3D packet to the MS 100. The 3D packet received from the main server 120 and the 3D packet scaled-down and transmitted to the MS 100 are of the same format.

The main server 120 is a server for providing a 3D graphic service to the MS 100 and PC clients 130-1 and 130-2. For example, a game server, and the like can belong to the main server 120. The main server 120 transmits a PC-based large capacity 3D packet to the MS 100 and PC clients 130-1 and 130-2.

The PC clients 130-1 and 130-2 render a 3D packet received from the main server 120 and provide a 3D graphic service to a user.

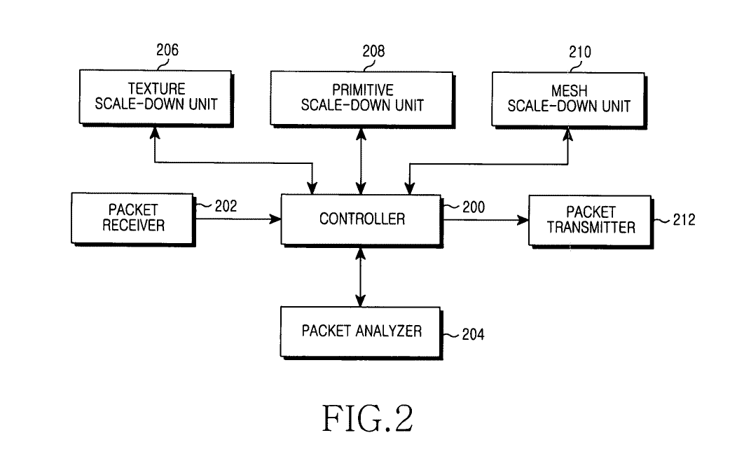

FIG. 2 illustrates a block diagram of a construction of an apparatus for scaling down and transmitting, by a proxy server, a 3D packet to an MS in a mobile environment according to an exemplary embodiment of the present invention.

As illustrated in FIG. 2, the proxy server includes a controller 200, a packet receiver 202, a packet analyzer 204, a texture scale-down unit 206, a primitive scale-down unit 208, a mesh scale-down unit 210, and a packet transmitter 212.

Referring to FIG. 2, the controller 200 controls a general operation of the proxy server. Particularly, the controller 200 processes a function for analyzing a 3D packet received from a main server, scaling down the received packet in a different scheme depending on the analysis result, and transmitting the scaled-down packet to the MS.

The packet receiver 202 receives a packet from the main server, and outputs the received packet to the controller 200.

The packet analyzer 204 analyzes a packet input from the controller 200, and outputs the analysis result to the controller 200. The packet analysis is implemented using a header of the packet.

The texture scale-down unit 206 scales down a texture packet input from the controller 200, and outputs the scaled-down texture packet to the controller 200. That is, the texture scale-down unit 206 decompresses a texture image included in the texture packet, decreases a size of the texture image, and then regenerates and outputs a texture packet including the size-decreased texture image and a new texture packet header that is changed according to the decrease of the size of the texture image.

The primitive scale-down unit 208 scales down a primitive packet input from the controller 200, and outputs the scaled-down primitive packet to the controller 200. That is, the primitive scale-down unit 208 analyzes a primitive parameter of the primitive packet, generates a primitive using the analyzed primitive parameter, decreases number of space figures constituting the generated primitive, and then regenerates and outputs a primitive packet including a new primitive parameter that is changed according to the decrease of the number of the space figures.

The mesh scale-down unit 210 scales down a mesh packet input from the controller 200, and outputs the scaled-down mesh packet to the controller 200. That is, the mesh scale-down unit 210 analyzes a mesh parameter of the mesh packet, generates a mesh using the analyzed mesh parameter, decreases number of plane figures (or number of points) constituting the generated mesh, and then regenerates and outputs a mesh packet including a new mesh parameter that is changed according to the decrease of the number of the plane figures (or the number of the points).

The packet transmitter 212 transmits a packet input from the controller 200 to the MS.

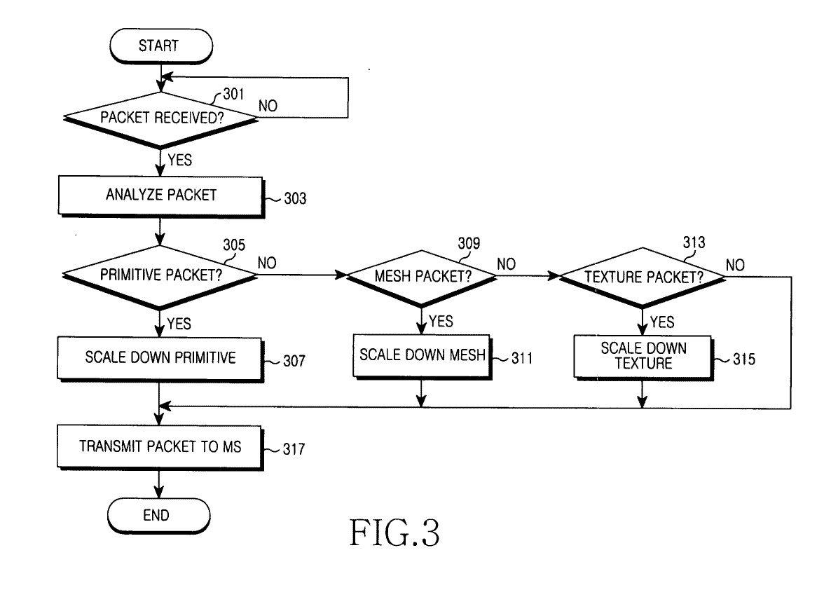

FIG. 3 illustrates a flow diagram for a procedure of a method for scaling down and transmitting, by a proxy server, a 3D packet to an MS in a mobile environment according to an exemplary embodiment of the present invention.

Referring to FIG. 3, in step 301, the proxy server determines if a packet is received from a main server. When the packet is received, in step 303, the proxy server analyzes the received packet. A header of the received packet includes information as to if the packet is a primitive packet, mesh packet, or texture packet of a 3D packet. Accordingly, the proxy server can analyze the received packet using the header of the received packet.

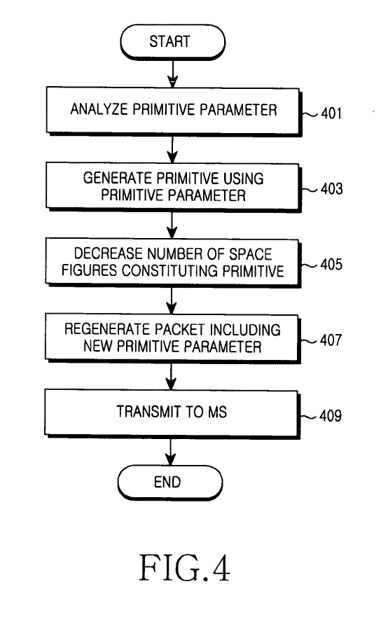

Then, in step 305, the proxy server determines if the received packet is the primitive packet of the 3D packet as the analysis result. If the received packet is the primitive packet of the 3D packet, in step 307, the proxy server scales down the received primitive packet. In step 317, the proxy server transmits the scaled-down primitive packet to the MS. Scaling down and transmitting of the primitive packet are described later in detail through FIG. 4.

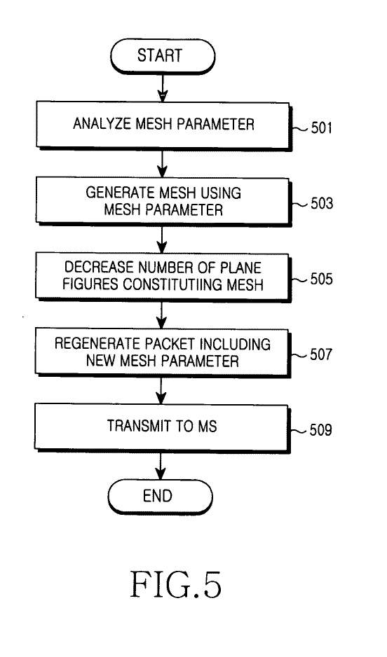

Conversely, if the received packet is not the primitive packet among the 3D packet in step 305, the proxy server goes to step 309 and determines if the received packet is the mesh packet of the 3D packet as the analysis result. If the received packet is the mesh packet of the 3D packet, in step 311, the proxy server scales down the received mesh packet. In step 317, the proxy server transmits the scaled-down mesh packet to the MS. Scaling down and transmitting of the mesh packet are described later in detail through FIG. 5.

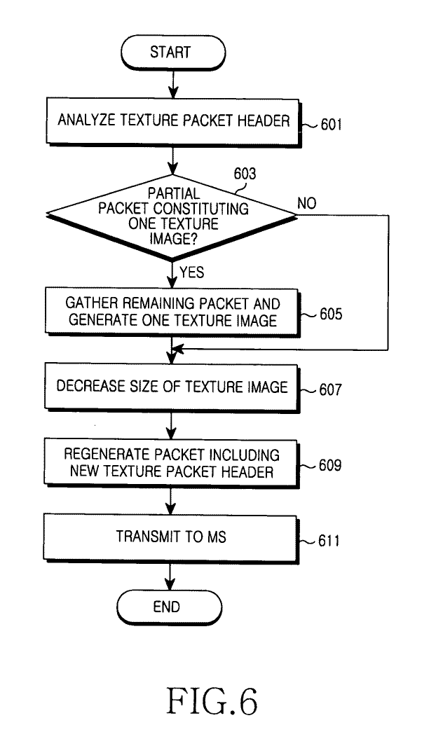

Conversely, if the received packet is not the mesh packet among the 3D packet in step 309, the proxy server goes to step 313 and determines if the received packet is the texture packet of the 3D packet as the analysis result. If the received packet is the texture packet of the 3D packet, in step 315, the proxy server scales down the received texture packet. In step 317, the proxy server transmits the scaled-down texture packet to the MS. Scaling down and transmitting of the texture packet are described later in detail through FIG. 6.

Conversely, if the received packet is not the texture packet of the 3D packet in step 313, the proxy server determines that the received packet is not the 3D packet, and directly goes to step 317 and transmits the received packet to the MS.

Then, the proxy server terminates the procedure of the present invention.

FIG. 4 illustrates a flow diagram for a procedure of a method for scaling down and transmitting, by a proxy server, a primitive packet to an MS in a mobile environment according to an exemplary embodiment of the present invention.

Referring to FIG. 4, in step 401, the proxy server analyzes a primitive parameter of a primitive packet depending on primitive packet reception from a main server. The primitive parameter includes number of unit space figures constituting a corresponding primitive, and a 3D coordinate of each unit space figure.

Then, in step 403, the proxy server generates a primitive using the analyzed primitive parameter. In step 405, the proxy server decreases number of space figures constituting the generated primitive. For example, as in FIG. 7, assuming that the proxy server can generate a primitive comprised of eight unit space figures using the primitive parameter of the primitive packet received from the main server, the proxy server can change the generated primitive into a primitive having the same size as the generated primitive while having a decrease of number of included space figures, by three-dimensionally increasing a size of one of the eight unit space figures.

Then, in step 407, the proxy server regenerates a primitive packet including a new primitive parameter that is changed according to the decrease of the number of the space figures. In an example of FIG. 7, the primitive parameter of the primitive packet received from the main server includes 3D coordinates for eight unit space figures, but the primitive parameter of the primitive packet regenerated by the proxy server can include only a 3D coordinate for one space figure. In this case, a size of the primitive packet regenerated by the proxy server decreases to ⅛ of a size of the primitive packet received from the main server.

Then, in step 409, the proxy server transmits the regenerated primitive packet to the MS. As such, the proxy server changes a PC-based 3D packet from the main server to a small size suitably to an MS capacity (e.g. a resolution) and transmits the changed 3D packet. By this, the MS can perform rendering for a 3D graphic in an optimal condition of a corresponding computing environment.

Then, the proxy server terminates the procedure of the present invention.

FIG. 5 illustrates a flow diagram for a procedure of a method for scaling down and transmitting, by a proxy server, a mesh packet to an MS in a mobile environment according to an exemplary embodiment of the present invention.

Referring to FIG. 5, in step 501, the proxy server analyzes a mesh parameter of a mesh packet depending on mesh packet reception from a main server. The mesh parameter includes number of unit plane figures constituting a corresponding mesh (particularly, number of triangles that are 3D minimum constituent units), and a 2D coordinate of each unit plane figure. Alternatively, the mesh parameter can also include number of points and a 2D coordinate of each point.

Then, in step 503, the proxy server generates a mesh using the analyzed mesh parameter. In step 505, the proxy server decreases number of plane figures (or number of points) constituting the generated mesh. For example, as in FIG. 8, assuming that the proxy server can generate a mesh comprised of eight unit plane figures (or nine points) using the mesh parameter of the mesh packet received from the main server, the proxy server can change the generated mesh into a mesh having the same size as the generated mesh while having a decrease of number of included plane figures to two (or a decrease of number of points to four), by two-dimensionally increasing sizes of two of the eight unit plane figures.

Then, in step 507, the proxy server regenerates a mesh packet including a new mesh parameter that is changed according to the decrease of the number of the plane figures (or the number of the points). In an example of FIG. 8, the mesh parameter of the mesh packet received from the main server includes 2D coordinates for eight unit plane figures, but the mesh parameter of the mesh packet regenerated by the proxy server can include only 2D coordinates for two plane figures. In this case, a size of the mesh packet regenerated by the proxy server decreases to ¼ of a size of the mesh packet received from the main server.

Then, in step 509, the proxy server transmits the regenerated mesh packet to the MS. As such, the proxy server changes a PC-based 3D packet from the main server to a small size suitably to an MS capacity (e.g. a resolution) and transmits the changed 3D packet. By this, the MS can perform rendering for a 3D graphic in an optimal condition of a corresponding computing environment.

Then, the proxy server terminates the procedure of the present invention.

FIG. 6 illustrates a flow diagram for a procedure of a method for scaling down and transmitting, by a proxy server, a texture packet to an MS in a mobile environment according to an exemplary embodiment of the present invention.

Referring to FIG. 6, in step 601, the proxy server analyzes a header of a texture packet depending on texture packet reception from a main server. The header of the texture packet includes information representing that data included in the texture packet is a texture image, and size information and format information of the texture image. The texture image is included in the texture packet in a compressed state.

Then, in step 603, the proxy server determines if the texture packet is part of packets constituting one texture image. If the texture packet is the part of the packets constituting one texture image, in step 605, the proxy server receives and gathers a remaining packet and generates one texture image. Conversely, if the texture packet is not the packet constituting one texture image, the proxy server directly goes to step 607.

Then, in step 607, the proxy server decompresses a texture image generated by receiving and gathering a plurality of texture packets, or a texture image comprised of one texture packet, and decreases a size of a corresponding texture image. For example, the proxy server can decrease a texture image size of 128×128 to a size of 64×64.

Then, in step 609, the proxy server regenerates a texture packet including the size-decreased texture image, and a new texture packet header that is changed according to the decrease of the size of the texture image.

Then, in step 611, the proxy server transmits the regenerated texture packet to the MS. As such, the proxy server changes a PC-based 3D packet from a main server to a small size suitably to an MS capability (e.g., a resolution) and transmits the changed 3D packet. By this, the MS can perform rendering for a 3D graphic in an optimal condition of a corresponding computing environment.

Then, the proxy server terminates the procedure of the present invention.

As described above, the present invention has an advantage of being capable of improving the performance and quality of a 3D graphic service of an MS while reducing a load of 3D processing of the MS in a mobile environment, by scaling down and transmitting, by a proxy server, a 3D packet from a main server and, by the MS, rendering the scaled-down 3D packet and providing a 3D graphic service to a user in the mobile environment. Also, by filtering a packet through the proxy server, the present invention can eliminate information not actually having to be processed in the mobile environment, thus being capable of improving real time and preventing an unexpected packet loss.

Also, the MS has a smart 3D render enabling high performance and high quality output, thus being capable of rendering a 3D packet transmitted from a main server and a proxy server. The render reflects a special rendering technology necessary for a mobile 3D environment as well as visibility culling, thus being able to improve performance and quality even in a limited computing environment.

Also, because the MS takes charge of rendering, the MS can reduce a load of a proxy server and maintain number of accesses per proxy server, and can decrease number of 3D packets and improve the real time of the MS. Further, a render exists within the MS and thus, although a proxy server does not exist, the MS can connect with a main server and provide its own 3D graphic service.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for processing a 3-Dimensional (3D) packet in a proxy server, the method comprising:
receiving a 3D packet from a main server;
generating a set of unit figures constituting a 3D image using a parameter of the received 3D packet; and
increasing a size of a partial unit figure in the generated set of the unit figures, and generating a set of the same size as the generated set of the unit figures, by figures of less number than the generated set of the unit figures.

2. The method of claim 1, wherein the 3D packet is one of a primitive packet and a mesh packet.

3. The method of claim 1, wherein the set of the unit figures is one of a primitive and a mesh.

4. The method of claim 1, wherein the figure is one of a space figure and a plane figure.

5. The method of claim 1, further comprising:
regenerating a 3D packet comprising a new parameter that is changed according to a decrease of number of the figures; and
transmitting the regenerated 3D packet to a mobile station.

6. The method of claim 1, wherein the parameter comprises at least one of number of unit figures within the set of the unit figures for constituting the 3D image, and a coordinate of each unit figure.

7. The method of claim 1, further comprising: if the 3D packet received from the main server is a texture packet,
decreasing a size of a texture image comprised in the texture packet;
regenerating a texture packet comprising the size-decreased texture image; and
transmitting the regenerated texture packet to an MS.

8. The method of claim 7, further comprising decompressing the texture image.

9. The method of claim 7, further comprising, if the texture packet is part of packets constituting one texture image, receiving and gathering a remaining packet and generating one texture image.

10. An apparatus for processing a 3-Dimensional (3D) packet in a proxy server, the apparatus comprising:
a packet receiver for receiving a 3D packet from a main server; and
a scale-down unit for generating a set of unit figures constituting a 3D image using a parameter of the received 3D packet, increasing a size of a partial unit figure in the generated set of the unit figures, and generating a set of the same size as the generated set of the unit figures, by figures of less number than the generated set of the unit figures.

11. The apparatus of claim 10, wherein the 3D packet is one of a primitive packet and a mesh packet.

12. The apparatus of claim 10, wherein the set of the unit figures is one of a primitive and a mesh.

13. The apparatus of claim 10, wherein the figure is one of a space figure and a plane figure.

14. The apparatus of claim 10, wherein the scale-down unit regenerates a 3D packet comprising a new parameter that is changed according to a decrease of number of the figures.

15. The apparatus of claim 14, further comprising a packet transmitter for transmitting the regenerated 3D packet to a mobile station.

16. The apparatus of claim 10, wherein the parameter comprises at least one of number of unit figures within the set of the unit figures for constituting the 3D image, and a coordinate of each unit figure.

17. The apparatus of claim 10, wherein, if the 3D packet received from the main server is a texture packet, the scale-down unit decreases a size of a texture image comprised in the texture packet, and regenerates a texture packet comprising the size-decreased texture image.

18. The apparatus of claim 17, wherein the scale-down unit decompresses the texture image.

19. The apparatus of claim 17, wherein, if the texture packet is part of packets constituting one texture image, the scale-down unit receives and gathers a remaining packet and generates one texture image.

20. A system comprising:
a server;
mobile station; and
a proxy server, the proxy server comprising an apparatus for processing a 3-Dimensional (3D) packet, the apparatus comprising:
a packet receiver for receiving a 3D packet from a main server; and
a scale-down unit for generating a set of unit figures constituting a 3D image using a parameter of the received 3D packet, increasing a size of a partial unit figure in the generated set of the unit figures, and generating a set of the same size as the generated set of the unit figures, by figures of less number than the generated set of the unit figures.
